(19) United States
(12) Patent Application Publication
(10) Pub. No.: US 2018/0054461 A1
(43) Pub. Date: Feb. 22, 2018

(54) ALLOWING ACCESS TO FALSE DATA

(71) Applicant: Lenovo (Singapore) Pte Ltd., New Tech Park (SG)

(72) Inventors: Justin Tyler Dubs, Raleigh, NC (US); Christopher Aaron Whitesock, Clayton, NC (US); Timothy Winthrop Kingsbury, Cary, NC (US)

(21) Appl. No.: 15/237,829

(22) Filed: Aug. 16, 2016

(51) Int. Cl. H04L 29/06; G06F 21/55

(52) U.S. Cl. CPC H04L 63/1491; G06F 21/554; H04L 2463/146; G06F 2221/2123; H04L 63/0281

(57) ABSTRACT

In one aspect, a device includes a processor and storage accessible to the processor. The storage bears instructions executable by the processor to determine that an attempt has occurred of unauthorized access to a computer system having a computer interface for presentation to an authorized user. The instructions are also executable to, responsive to determining that an attempt has occurred of unauthorized access to the computer system, return from the computer system a proxy interface instead of the computer interface, the proxy interface permitting access to at least partially falsified data.

### FIELD

The present application relates generally to allowing hackers access to false data.

### BACKGROUND

As recognized herein, hackers all too frequently attempt to gain access to innocent computer systems via brute-force techniques or password guessing. So-called “honeypot” systems have been introduced that are intentionally vulnerable to draw an attacker's attention and admit access, but as also recognized herein, such tools can seem suspicious to experienced hackers, and in any case are unhelpful against attacks on individual machines such as employee laptops or smartphones.

### SUMMARY

Accordingly, in one aspect a device includes a processor and storage accessible to the processor. The storage bears instructions executable by the processor to determine that an attempt has occurred of unauthorized access to a computer system having a computer interface for presentation to an authorized user. The instructions are executable to, responsive to determining that an attempt has occurred of unauthorized access to the computer system, return from the computer system a proxy interface instead of the computer interface. The proxy interface permits access to at least partially falsified data.

The falsified data may include a falsified credit card number, a falsified password, and/or a falsified user account. The falsified data may be digitally watermarked to facilitate tracking the falsified data.

In some examples, the instructions can be executable to activate key stroke recording to record all key strokes received by the proxy interface. In some examples, the instructions can be executable to activate a camera coupled to the computer system. Also in some examples, the instructions may be executable to determine that an attempt has occurred of unauthorized access to the computer system at least in part based on a determination that a number of failed login attempts satisfies a threshold. If desired, the instructions may be executable to, responsive to determining that an attempt has occurred of unauthorized access to the computer system, transmit a message to an administrator account.

In another aspect, a computer readable storage medium that is not a transitory signal includes instructions executable by a processor to detect an attack on a computer system, and responsive to detecting an attack on a computer system, return a proxy version of a legitimate interface of the computer system. The proxy version includes plural proxy selectors corresponding to respective selectors on the legitimate interface. Selection of a proxy selector invokes sham data corresponding to data invoked responsive to selection of the respective selector on the legitimate interface but sanitized of sensitive information accessible through the legitimate interface.

In another aspect, a method includes establishing a proxy interface appearing like a legitimate interface of a computer system. The method also includes, responsive to correct login to the computer system, returning the legitimate interface, and responsive to detecting an attack on the computer system, returning the proxy interface.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is an example block diagram of a network of devices in accordance with present principles;

FIG. 3 is a block diagram of an example hacker attempting to gain access to an example computer system;

FIG. 4 is a screen shot of an example user interface (UI) according to present principles;

FIG. 5 is a schematic representation of the correspondence between sham data and authentic data; and

FIG. 6 is a flow chart of an example algorithm in accordance with present principles.

### DETAILED DESCRIPTION

The present disclosure relates to improving the security of individual computer systems by allowing attackers to appear to gain access, but then presenting only a false representation of the system. When the attacker attempts to guess passwords, unlock patterns, etc., rather than continuing to fail, the hacker is allowed to falsely succeed (e.g., to gain access to a sandbox and/or a virtual machine image that establishes the false representation of the system). As understood herein, this is preferable to failure, as failure will simply incentivize the attacker to continue trying until true credentials are found, or until another true weakness in the system is found. So, upon apparently “successful” (but actually failed) hacking of the system, the system will present a synthetic sanitized version of its normal interface but without any of the system's true sensitive information present.

In one embodiment, false data including sham user accounts, sham passwords, sham credit card numbers, etc. can be provided in response to the false login. This data can be self-identifying (watermarked) so that if found elsewhere it can be determined which server was attacked. In addition or alternatively, upon allowing a false login to the device, keystrokes can be recorded, photographs taken with the devices camera, etc., to aid in identifying the attacker. Notifications of false may be sent to device administrator accounts via backchannels such as short message service (SMS), email, etc.

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are sometimes set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by, e.g., a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g., that is not a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

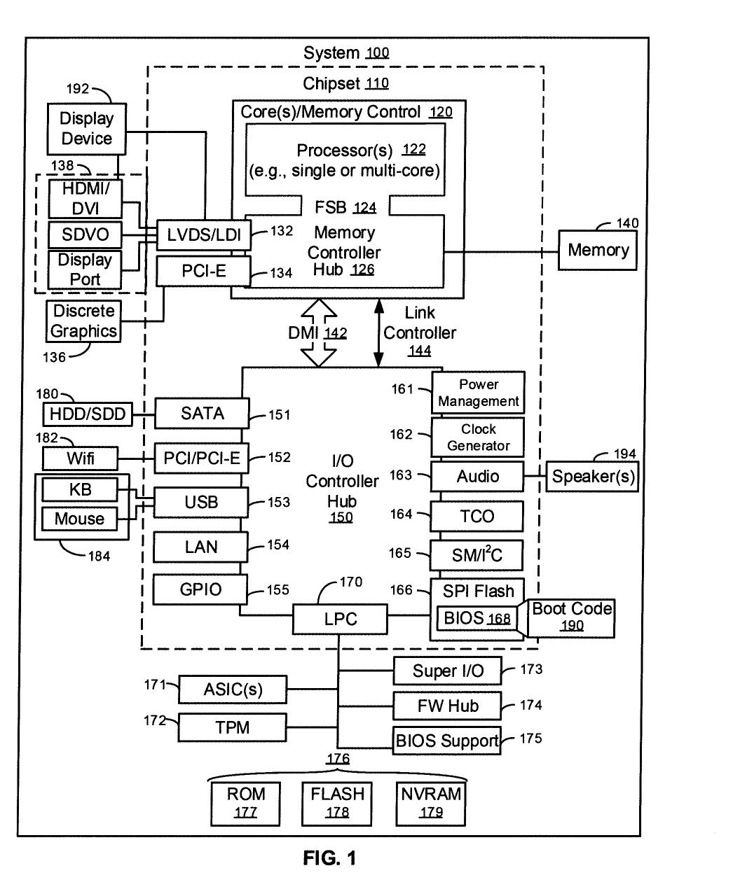

Now specifically in reference to FIG. 1, an example block diagram of an information handling system and/or computer system 100 is shown. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a wireless telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB) and mice, microphones and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for clarity, in some embodiments the system 100 may include a gyroscope that senses and/or measures the orientation of the system 100 and provides input related thereto to the processor 122, an accelerometer that senses acceleration and/or movement of the system 100 and provides input related thereto to the processor 122, an audio receiver/microphone that provides input from the microphone to the processor 122 based on audio that is detected, such as via a user providing audible input to the microphone, and a camera that gathers one or more images and provides input related thereto to the processor 122. The camera may be a thermal imaging camera, a digital camera such as a webcam, a three-dimensional (3D) camera, and/or a camera otherwise integrated into the system 100 and controllable by the processor 122 to gather pictures/images and/or video. Still further, and also not shown for clarity, the system 100 may include a GPS transceiver that is configured to receive geographic position information from at least one satellite and provide the information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

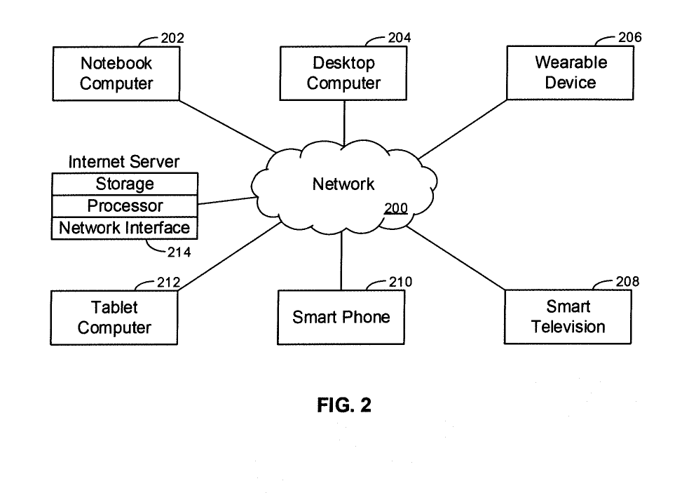

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 to undertake present principles.

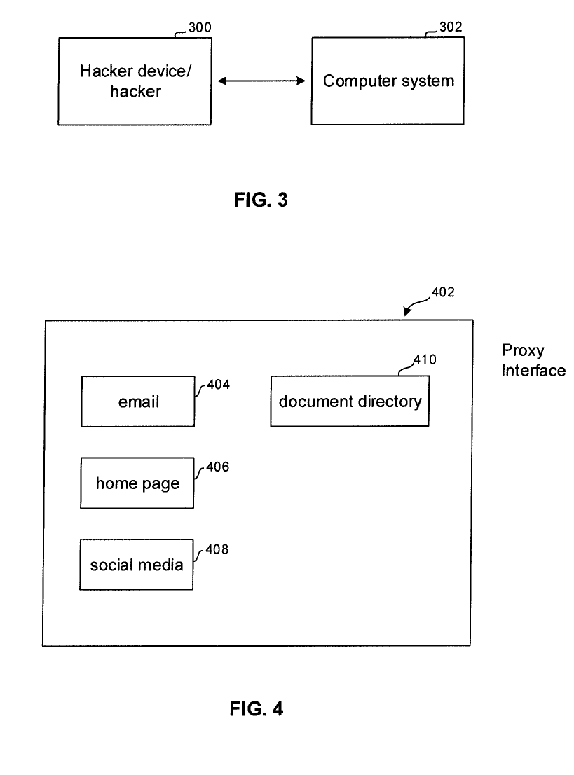

Referring to FIG. 3, a hacker 300 is illustrated attempting to gain access to a computer system 302 that may be implemented by any of the above-described systems, including, for example, an individual laptop computer or smart phone or personal digital assistant. The hacker 300 may be a human hacker present at the computer system 302 and attempting to log into the system 302 using an input device of the system 302, or the hacker may be a remote computer operated by a nefarious person and attempting to gain access to the computer system 302 over a wired or wireless computer network. In any case, the hacker 300 is assumed to be unauthorized for accessing the system 302.

FIG. 4 illustrates a proxy interface 402 that may be returned by the computer system 302 in FIG. 3 responsive to determining that an attempt has been made for unauthorized access to the system 302 according to further description below. The determination that an attempt has been made for unauthorized access may be based on the hacker using login credentials that have been flagged as and/or are recognizable by the system 302 as sham login credentials, for instance. The proxy interface 402 may be returned to a hacker device 300 over a computer network or it may be presented on the computer system 302 to a hacking individual operating an input device of the system to attempt to gain access.

It is to be understood that the proxy interface 402 is a version of a legitimate interface of the computer system 302 such as for presentation of application selectors, in that, in the example shown, the proxy version is identical in appearance and configuration to the legitimate interface but does not return the same data otherwise returned by the legitimate interface. The proxy interface need not be identical to the legitimate interface in appearance and configuration, however.

In the desktop interface example shown, the proxy interface 402 includes proxy selectors corresponding to respective selectors on the legitimate interface. For example, the proxy interface 402 may include an apparent email invocation selector 404 that would appear to be selectable to access an email account, an Internet home page invocation selector 406 that would appear to be selectable to access an Internet home page, potentially with the user already logged in or with the login credentials remembered, a social media Internet site invocation selector 408, and document directory invocation selector 410.

Selection of one of the proxy selectors 404-410, however, unlike selection of the corresponding selectors on the legitimate interface, does not invoke what the proxy selectors feign to invoke. Instead, selection of a proxy selector invokes presentation of sham data that in some cases may correspond to data invoked responsive to selection of the respective selector on the legitimate interface but sanitized of sensitive information otherwise accessible through the legitimate interface.

For example, selection of the proxy email selector 404 may return an email interface with a sham account, including a sham contact list with non-existent email addresses listed and a false password that is not a legitimate password. The proxy interface may also return, depending on the context, not a true credit card number but rather a sham or falsified credit card number that in reality does not match any credit card number issued by a financial institution.

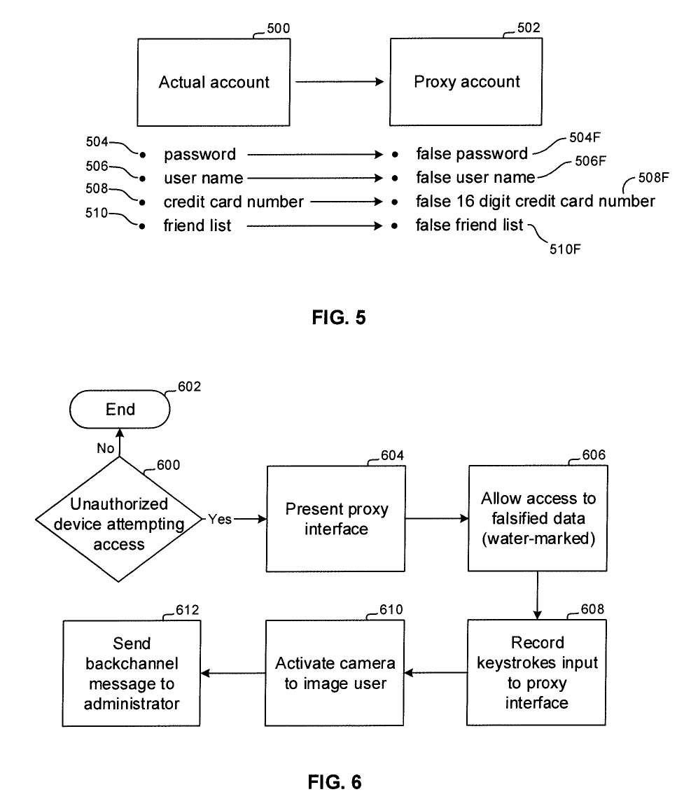

FIG. 5 schematically illustrates the above principles in further detail. An actual account 500 may be associated with the legitimate interface that is accessible by using correct authentication input, e.g., correct user name and password. A corresponding proxy account 502 may be provided as discussed above. The true password 504 of the actual account 500 may be modified or otherwise rendered false such that the proxy account 502 includes a false password 504F. Similarly, the true user name 506 of the actual account 500 may be modified or otherwise rendered false such that the proxy account 502 includes a false user name 506F, while a true credit card number 508 contained in the actual account 500 may be modified or otherwise rendered false such that the proxy account 502 includes a false credit card number 508F. And, the true friend or contact list 510 the actual account 500 may be modified or otherwise rendered false such that the proxy account 502 includes a false friend or contact list 510F.

The false data 504F-510F may be accessed in the same portions of the proxy account 502 as the corresponding actual data 504-510 are otherwise accessible in the legitimate, actual account 500.

FIG. 6 illustrates an algorithm in accordance with principles discussed herein. If no unauthorized access attempts are detected at diamond 600, the logic may end at state 602, but otherwise the logic can move to block 604 to return the proxy interface according to description above. In one embodiment, a positive test at diamond 600 may be returned responsive to input of incorrect authentication information for “N” successive attempts within a period of M minutes, wherein N and M are integers greater than one.

Other tests may be used to determine whether unauthorized access is being attempted. For example, if an unauthorized biometric signal is input to the computer a single time, the test at diamond 600 may be positive. Additionally or alternatively, if remote access is being attempted from a predetermined geographic location, e.g., a location known to be a haven for hackers, even a single time, the test at diamond 600 may be positive. Additionally or alternatively, if falsified login credentials are used in an attempt to gain access, the test at diamond 600 may be positive.

Moving from block 604 to block 606, as mentioned above access may be allowed to the putative hacker to falsified data. The falsified data may be digitally watermarked so that if the hacker subsequently attempts to use the falsified, the watermark can be detected. The watermark may identify the computer system 302 from which the sham data is obtained. For example, a watermark or seed included with the falsified data may itself include a particular IP address associated with the system 302, or another type of identifier for the system 302. Additionally or alternatively, the falsified data may use other seeded randomness so that the seed can be identified later by a system administrator.

If desired, pursuant to a positive test at diamond 600 all keystrokes input to the computer system 302 by means of, e.g., the proxy interface may be recorded at block 608 for subsequent investigatory purposes. Also, an imager on or coupled to the computer system 302 may be activated at block 610 to obtain a still or video image of the area around the computer system 302 to thereby possibly image an in-person hacker. Backchannel messages reporting the hacking may be sent at block 612, preferably as soon as possible after detection of the hack attempt. The messages may be sent to system administrator accounts, law enforcement, the true user, etc.

Before concluding, it is to be understood that although a software application for undertaking present principles may be vended with a device such as the system 100, present principles apply in instances where such an application is downloaded from a server to a device over a network such as the Internet. Furthermore, present principles apply in instances where such an application is included on a computer readable storage medium that is being vended and/or provided, where the computer readable storage medium is not a transitory signal and/or a signal per se.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A device, comprising:
a processor; and
storage accessible to the processor and bearing instructions executable by the processor to:
determine that an attempt has occurred of unauthorized access to a computer system having a computer interface for presentation to an authorized user; and
responsive to determining that an attempt has occurred of unauthorized access to the computer system, return from the computer system a proxy interface instead of the computer interface, the proxy interface permitting access to at least partially falsified data.

2. The device of claim 1, wherein the at least partially falsified data comprises a falsified credit card number.

3. The device of claim 1, wherein the at least partially falsified data comprises a falsified password.

4. The device of claim 1, wherein the at least partially falsified data comprises a falsified user account.

5. The device of claim 1, wherein the at least partially falsified data is digitally watermarked to facilitate tracking the at least partially falsified data.

6. The device of claim 1, wherein the instructions are executable by the processor to:
responsive to determining that an attempt has occurred of unauthorized access to the computer system, activate key stroke recording to record all key strokes received at the proxy interface.

7. The device of claim 1, wherein the instructions are executable by the processor to:
responsive to determining that an attempt has occurred of unauthorized access to the computer system, activate a camera coupled to the computer system.

8. The device of claim 1, wherein the instructions are executable by the processor to:
determine that an attempt has occurred of unauthorized access to the computer system at least in part based on a determination that a number of failed login attempts satisfies a threshold.

9. The device of claim 1, wherein the instructions are executable by the processor to:
responsive to determining that an attempt has occurred of unauthorized access to the computer system, transmit a message to an administrator account.

10. A computer readable storage medium (CRSM) that is not a transitory signal, the computer readable storage medium comprising instructions executable by a processor to:
detect an attack on a computer system; and
responsive to detecting an attack on a computer system, return a proxy version of a legitimate interface of the computer system, the proxy version comprising plural proxy selectors corresponding to respective selectors on the legitimate interface, selection of a proxy selector invoking sham data corresponding to data invoked responsive to selection of the respective selector on the legitimate interface but sanitized of sensitive information accessible through the legitimate interface.

11. The CRSM of claim 10, wherein the proxy selectors comprise at least one email invocation selector.

12. The CRSM of claim 10, wherein the proxy selectors comprise at least one Internet home page invocation selector.

13. The CRSM of claim 10, wherein the proxy selectors comprise at least one social media Internet site invocation selector.

14. The CRSM of claim 10, wherein the proxy selectors comprise at least one document directory invocation selector.

15. The CRSM of claim 10, wherein the wherein the sham data comprises a falsified credit card number.

16. The CRSM of claim 10, wherein the wherein the sham data comprises a falsified password.

17. The CRSM of claim 10, wherein the wherein the sham data comprises a falsified user account.

18. The CRSM of claim 10, wherein the sham data is digitally watermarked to facilitate tracking the sham data.

19. A method, comprising:
establishing a proxy interface appearing like a legitimate interface of a computer system;
responsive to correct login to the computer system, returning the legitimate interface; and
responsive to detecting an attack on the computer system, returning the proxy interface.

20. The method of claim 19, comprising watermarking data returned from the proxy interface.
